(19) United States
(12) Patent Application Publication
(10) Pub. No.: US 2002/0015636 A1
(43) Pub. Date: Feb. 7, 2002

(54) FOUP door opening apparatus of FOUP opener and latch key control method

(75) Inventors: Wan Keun Lee, Seoul (KR); Youg Pyo Kim, Songnam-city (KR)

Correspondence Address: Frank Chau, F. CHAU & ASSOCIATES, LLP, 1900 Hempstead Turnpike, Suite 501, East Meadow, NY, 11554, US

(73) Assignee: Shinsung Eng Corporation

(21) Appl. No.: 09/921,877

(22) Filed: Aug. 3, 2001

(30) Foreign Application Priority Data
Aug. 4, 2000 (KR) 2000-45281
Aug. 4, 2000 (KR) 2000-45282
Jan. 16, 2001 (KR) 2001-2370
Jul. 14, 2001 (KR) 2001-42557

(51) Int. Cl. B65F 3/02

(52) U.S. Cl. 414/407

(57) ABSTRACT

The present invention relates to a FOUP door opening apparatus capable of stably supporting a FOUP door, implementing a smooth door locking and unlocking operation and preventing a particle from being introduced into the system when opening a FOUP door. The FOUP door opening apparatus includes a door opening unit having a front end having a latch key and a rear end having a worm wheel wherein the work wheel is engaged with a worm, and the worm is connected with a driving motor shaft, a particle discharging unit which has a suction hole at a certain portion wherein the suction hole is connected with a suction and discharging unit having a certain pressure for thereby sucking and discharging the particles to the outside when opening the door, and a door support unit which includes buffering rollers installed at both ends of the latch key for enhancing a contact feel and implementing a door support based on an expansion force of the compressed air before the FOUP door is opened.

### BACKGROUND OF THE INVENTION

1. Field of the Invention

The present invention relates to a FOUP door opening apparatus of a FOUP opener and a latch key control method, and in particular to a FOUP door opening apparatus of a FOUP opener and a latch key control method which is capable of implementing a stable operation of a FOUP door by preventing a particle from being introduced when opening a FOUP door, and enhancing a latch key contact feeling and a support force with respect to a FOUP door.

2. Description of the Background Art

Generally, a semiconductor wafer has a certain cleanness and stability and is moved into a word place. At this time, the wafer is moved into a FOUP (a moving container) and is moved to an entrance of a semiconductor fabrication facility in a separated state. Thereafter, a FOUP door is opened in a FOUP opener installed at an entrance of a separated semiconductor fabrication facility, and the wafer is moved into the interior of a semiconductor process equipment. The conventional FOUP opener will be explained with reference to FIG. 1.

FIG. 1 is a view illustrating a conventional FOUP opener 100 and a FOUP 200.

The FOUP opener 100 has a certain cleanness and is installed at an entrance of a process equipment separated from an external place. In the FOUP opener 100, a horizontal support 104 is installed in a vertical frame 102. A transfer table 106 is installed in the support 104 of the FOUP opener 100, and a door holder 110 having the same size as the FOUP is installed in the vertical frame 102.

The door FOUP 110 is forwardly and backwardly moved in the inner direction and includes a latch key 112 and a support unit 120 for opening the door 210 of the FOUP placed on the transfer table 106.

The FOUP 200 is opened in such a manner that the FOUP 200 is closely contacted with the door holder 110. The door 210 of the closely contacted FOUP 200 is opened by unlocking the door by the latch key 112 in a state that the door 210 is sucked and supported by the support unit 120 and backwardly moving the door holder 110.

The FOUP is locked and unlocked by inserting the latch key 112 installed in the door holder 110 of the opener 100 into a latch key hole 220 formed in the door 210 of the FOUP.

The door holder 110 includes two support units 120 and supports the door 210 inserted into the suction hole 230 of the door 210.

The construction of the support unit 120 of the door holder 110 and the latch key 112 will be explained with reference to FIG. 2A.

FIG. 2A is a view illustrating the construction of the conventional latchkey driving apparatus.

A shown therein, the driving operation of the latch key 112 is implemented based on the belt driving method. A lead screw 115 supported by a certain coupling 113 is connected with a shaft of the driving motor 111, and a driving plate 117 is arranged with the lead screw 115 and is moved in the linear direction based on the rotation of the lead screw 115. The driving plate 117 is connected with a ball bushing 114 between the guide shaft 118 and is moved in the linear direction. An end portion of the driving plate 117 is fixed to the driving belt 119.

The driving belt 119 is wound on the pulleys 116. A latch key 112 is installed in the center portion of the pulley 116. Therefore, the latch key 112 is rotated based on the rotation of the driving belt 119.

There are problems in the driving force transfer process of the belt-based latch key driving method. Namely, a backlash occurs in the driving plate, and the driving belt is easily extended, and a certain error occurs in the angular control of the latch key.

FIG. 2B is a view illustrating the structure of a support unit of the conventional FOUP door. As shown therein, since the conventional support unit 120 is fabricated in an integral and complicated shape, a casting process is difficult compared to the assembling type, and the productivity is decreased, and the unit cost is increased.

FIG. 2C is a view illustrating an operation problem of the latch key of the conventional FOUP door. The latch key hole 88 of the FOUP 200 receives the latch keys 80a and 80b of the door holder 110 thereinto, and a certain margin is formed when opening the FOUP 200. When the latch keys 80a and 80b are inserted into the latch key hole 88 and is rotated, the latch keys 80a and 80b rotate the latch key hole 88 based on a certain angle margin of about 1˜2°.

Therefore, when the latch keys 80a and 80b are rotated 90° when locking the FOUP door, the latch key hole 88 is rotated by 88˜89°, and when inserting or separating the latch keys 80a and 80b, a certain collision and friction occurs with respect to the latch key hole 88 for thereby generating an abrasion on the contact surface.

When locking the FOUP door in the conventional apparatus, since the latch key hole 88 of the door 210 is not rotated 90°, a certain interference occurs between the latch keys 80a and 80b and the latch key hole 88, so that it is impossible to implement a correct insertion, and a particle may occur due to the forced contact and insertion.

FIG. 2D is a view illustrating a particle remaining state of the conventional FOUP opener. As shown therein, the vertical frame 102 of the FOUP and the process apparatus 130 have a cleanness different in left and right sides with respect to the boundary portion a.

Namely, the side of the vertical frame 102 in which the FOUP opener 100 is arranged has a low cleanness with respect to the boundary portion a, and the side of the process equipment 130 has a high cleanness. In addition, the FOUP has the same cleanness as the process equipment.

There are many particles in the outer portion of the process equipment, and the above particles are moved into the groove between the FOUP and the FOUP door and are moved in the direction of the process equipment when opening the opener. When the particles are introduced into the process equipment, a critical problem may occur in the fabrication of the semiconductor. Therefore, it is important to maintain a cleanness state in the process equipment.

The particles remain together with the polluted air in the driving portions of the latch key and the gap between the edge portion of the opening surface and the door. When the door is opened, the particles are introduced into the interior of the process equipment.

As shown in FIG. 2D, the gap “a” of the door 210 and the FOUP 200 communicated with the portion “b” in which a peripheral portion of the FOUP 200 and the vertical frame 102 contact and a space β between the door 210 and the door holder 110. At the time when the door 210 is opened, the particles remaining in the space are introduced into the interior of the FOUP.

In addition, the door holder 110 of the opener 100 is disconnected with the process equipment and forms a certain space “d” opened in the direction of the is FOUP door. The particles may be moved in the forward direction through a gap between the door holder 110 by a backward movement force of the door 210 and the door holder 110 which are backwardly moved after the FOUP door is opened or the particles are moved in the direction of the process equipment 130 through a gap between the door holder 110 and the back surface of the frame 102.

FIG. 2E is a view illustrating a state that the door holder is sucked to the conventional FOUP door. The FOUP door 210 includes a suction hole 230. Therefore, the support unit 120 of the door holder 110 sucks the door 210 based on a certain pneumatic force.

As shown therein, the support unit 120 is implemented in such a manner that a suction way is formed in the center pin 127 in the center portion, and a rubber cup 120a is formed in the peripheral portions, and a vacuum hose 126 is connected with the center pin 127 in the rear side of the rubber cup 120a.

The suction hole 230 is arranged with the center pin 127 for supporting the door 210 of the FOUP 200 mounted on the support 106, and the door 210 is sucked to the rubber cup 120a based on a certain vacuum pressure.

The support unit installed in the conventional door holder is formed of a suction member, a compressor and other control valves and hoses. The latch key driving unit of the FOUP door is formed of an actuator operated based on a pneumatic force. Therefore, the latch key driving unit is implemented based on a compression air facility for a vacuum suction of the FOUP door and an air compression facility structure which includes an opening and closing unit formed of the actuator.

In addition, in order to closely support the FOUP door, a suction member is inserted into the door fixing hole, and a vacuum pressure is applied thereto. However, the vacuum pressure may act as a repulsive force with respect to the door due to an elastic force of the rubber cup portion, so that a moving force may be supported at the ending time of the movement of the stage which carries the FOUP. The repulsive force of the rubber cup may cause a problem that the stage is backwardly moved when closing the door. Therefore, in the conventional art, the suction force may not be properly obtained from the door holder due to the above-described problems.

### SUMMARY OF THE INVENTION

Accordingly, it is an object of the present invention to provide a FOUP door opening apparatus of a FOUP opener and a latch key control method which is capable of implementing a simplified structure by fabricating and integrally assembling a latch key based on a direct driving method using a driving motor with respect to a latch key driving method.

It is another object of the present invention to provide a FOUP door opening apparatus of a FOUP opener and a latch key control method which is capable of implementing a smooth latch key insertion by properly controlling a latch key, compensating an angle of a latch key hole and setting the angle of the latch key hole of 90°, decreasing an abrasion due to a friction in the corresponding surfaces when the latch key is inserted into the latch key hole and is rotated therein and preventing the particles from being introduced from the latch key hole to the work space.

It is still another object of the present invention to provide a door holder capable of controlling a door opening and closing unit of the door holder contacting with the FOUP door and the door support unit using one air compression line and to provide a door support unit for stably supporting the door and door holder using a compressed air discharging pressure not by a vacuum pressure.

To achieve the above objects, there is provided a FOUP door opening apparatus which includes a door opening and closing means, and a particle discharging means for sucking and discharging a particle to the outside by connecting a suction hole formed in a certain portion of the door opening and closing means and a suction and discharging means having a certain pressure therein when opening and closing then door.

The door opening and closing means includes a front end having a latch key and an end portion having a worm wheel in which a worm is engaged with the worm wheel, and the worm is connected with a driving motor shaft.

The door opening and closing means includes buffering rollers at both ends of the same for thereby decreasing a contact friction when the latch key is inserted into the latch key hole and is rotated therein.

The particle discharging means is installed in a certain position in which the door between the FOUP opener and the FOUP is closely contacted with the door holder.

A particle filter is further installed at a certain portion of a casing which covers the door holder which is backwardly moved from the rear side of the door holder of the FOUP opener.

The particle discharging means is formed of a nozzle, a discharging hose connected with the nozzle, and a vacuum compressor for providing a discharging force to the discharging hose.

A particle discharging is formed in an inner center portion of the door opening and closing means for thereby discharging the particles therethrough.

A door support means is formed of a body having a female screw portion, an adjusting pin having a male screw portion engaged with the female screw portion and a suction way communicating with the body and the adjusting pin.

A sealing member is disposed between the body and the adjusting pin for implementing a sealed state therebetween.

A door support means is provided for supporting a door using an expansion force of a certain pressure by flowing a compressed air.

The door support means includes a guide head at an end portion of the same for a centering operation, and an intermediate portion formed of an expansion member wherein the expansion member is formed of a base portion for forming a compressed air supply way.

The expansion member is formed of a two-tier structure of an inner member and an outer member, and the inner member includes a plurality of discharging holes.

The expansion member includes a fixing ring at upper and lower portions for fixing to the support member.

To achieve the above objects, there is provided a FOUP door latch key control method which includes a step in which when a latch key inserted in a latch key hole is rotated 90°, the latch key is idle-rotated about 1˜2°, and the latch key is closely contacted with a corresponding surface of the latch key hole in a rotation direction for thereby rotating the latch key hole and unlocking the door, a step in which the unlocked door is opened, and a process is performed, a step in which when the process is finished, the door is closed, and the latch key is rotated 91° in the direction opposite when unlocking the latch key in the latch key hole for thereby locking the door, and a step in which when the door is locked, the latch key is reverse-rotated 1° in the direction opposite to the locking direction, and the latch key hole is arranged with the latch key for thereby separating the latch key from the latch key hole.

The step for unlocking the door, in the case that the latch key hole is not in the normal position in the previous process, but in a position slanted at an angle of 1°, the latch key is inserted into the latch key hole and is idle-rotated 2° and is closely contacted with the corresponding surface, and then the latch key is rotated.

The step for unlocking the door, in the case that the latch key hole is in the normal position in the previous process, the latch key is inserted into the latch key hole and is idle-rotated 1° and is closely contacted with the corresponding surface for thereby rotating the latch key hole.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a schematic structure of a conventional FOUP opener;

FIG. 2A is a view illustrating a schematic construction of a latch key driving principle of a conventional FOUP opener;

FIG. 2B is a view illustrating a structure of a latch key of a conventional FOUP opener;

FIG. 2C is a view illustrating a latch key rotation difference of a conventional FOUP opener;

FIG. 2D is a view illustrating a particle input state between a FOUP door and a door holder of a conventional FOUP opener;

FIG. 2E is a cross-sectional view illustrating a unit for sucking a FOUP door of a conventional FOUP opener;

FIGS. 3A through 3C are rear, front and side views of a door holder of a FOUP opener according to the present invention;

FIGS. 4A and 4B are rear and side enlarged views illustrating a latch key driving portion of FIG. 3;

FIG. 5 is a detailed cross-sectional view illustrating a latch key of FIG. 3C;

FIGS. 6A and 6B are front and side cross-sectional views illustrating an opener latch key according to another embodiment of the present invention;

FIGS. 7A and 7B are views illustrating an initial insertion state in which the latch keys are inserted into the latch key holes, in which:

FIG. 7A is a view illustrating a state that a latch key hole is not positioned in a normal position, but slanted by 1° in a rotation direction;

FIG. 7B is a view illustrating a state that a latch key hole is in a normal position;

FIG. 8 is a cross-sectional view illustrating a particle discharging unit adapted to a latch key of a FOUP opener according to the present invention;

FIG. 9 is a flow chart illustrating a latch key control method of a FOUP opener according to another embodiment of the present invention;

FIG. 10 is a cross-sectional view illustrating a FOUP door support unit of a FOUP opener according to the present invention;

FIGS. 11A and 11B are cross-sectional views illustrating a FOUP door support unit of a FOUP opener according to the present invention;

FIG. 12 is a cross-sectional view illustrating a structure of a particle discharging unit of a FOUP opener according to the present invention; and

FIG. 13 is a schematic cross-sectional view illustrating a particle discharging unit of a FOUP opener according to another embodiment of the present invention.

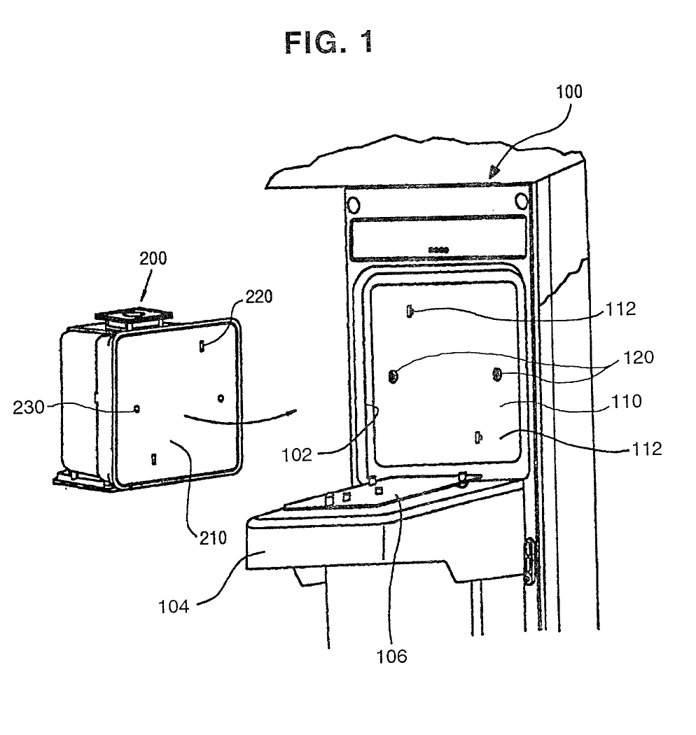

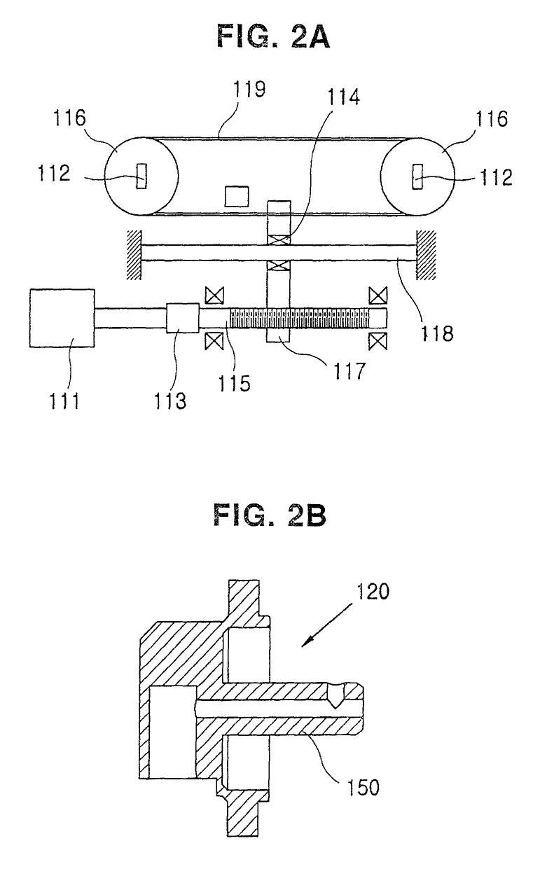

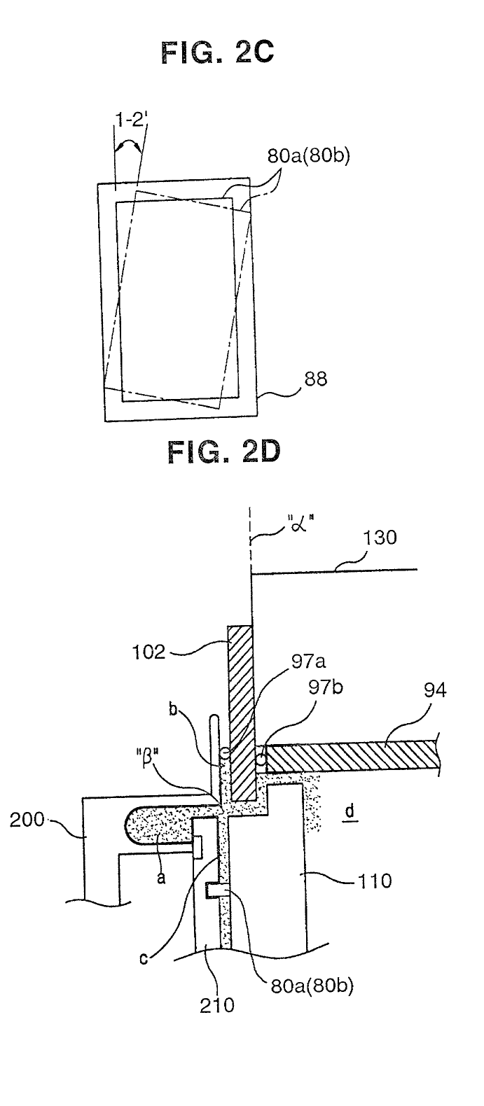

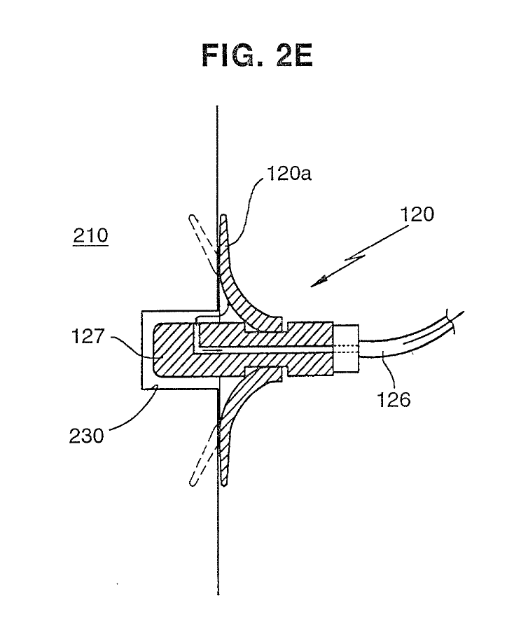

### DETAILED DESCRIPTION OF THE PREFERRED MBODIMENTS

The present invention will be explained with reference to the accompanying drawings.

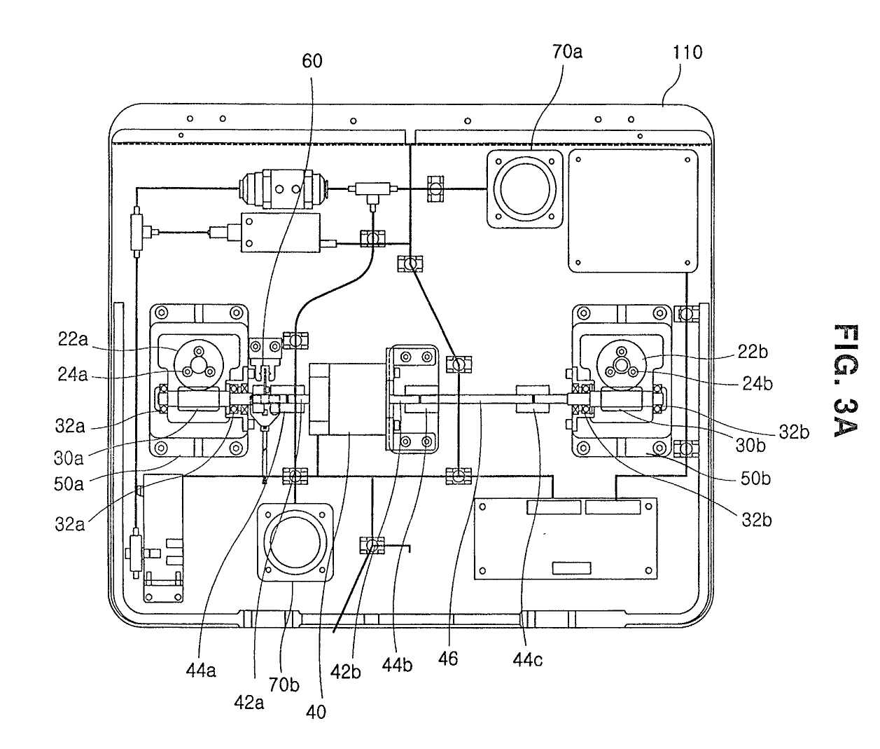

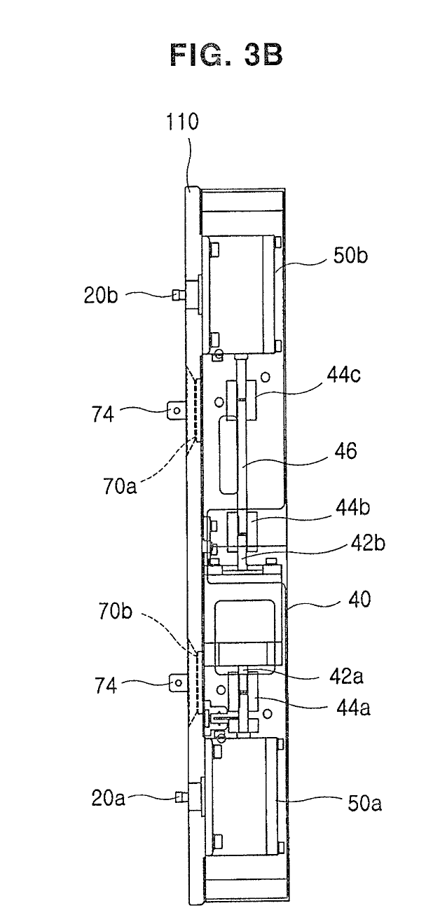

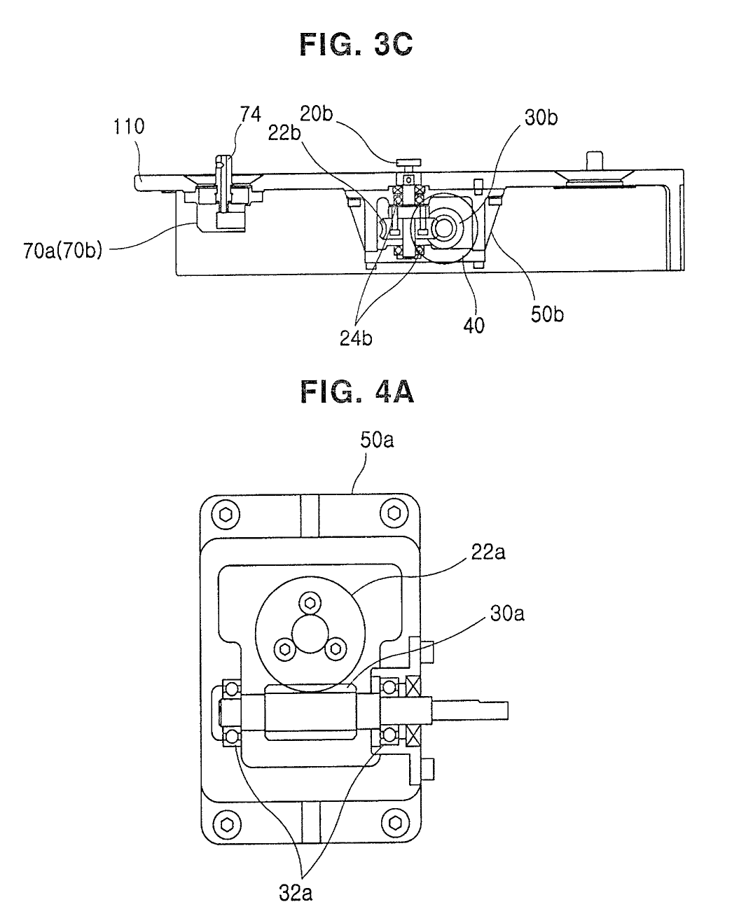

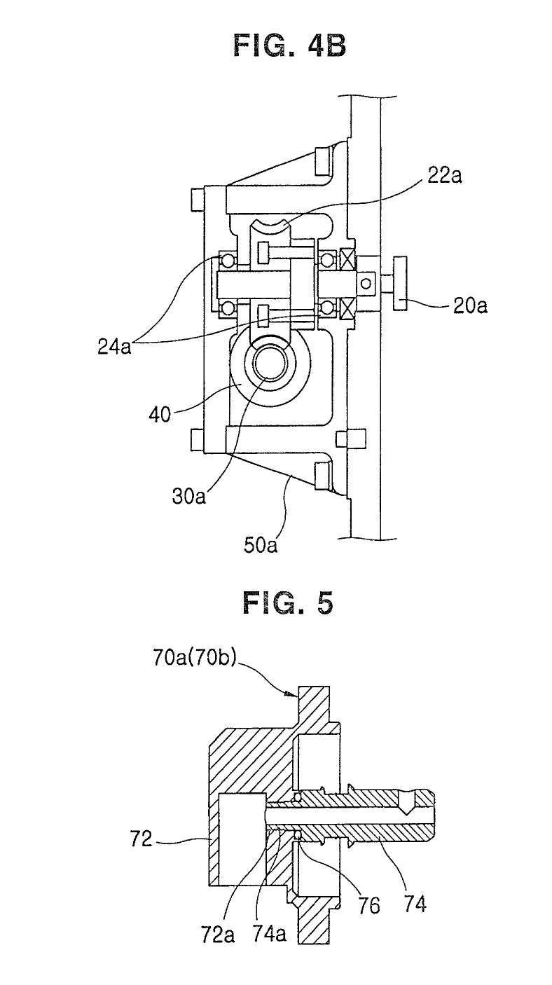

FIGS. 3A through 3C are rear, front and side views of a door holder of a FOUP opener according to the present invention, and FIGS. 4A and 4B are rear and side enlarged views illustrating a latch key driving portion of FIG. 3.

First and second latch keys 20a and 20b are horizontally installed in a main plate 10. The first and second latch keys 20a and 20b are spaced-apart from each other in a horizontal direction in an intermediate portion of the main plate 10, and a plurality of elements are installed in the back side of the same. Namely, first and second work wheels 22a and 22b are installed in the back surfaces of the first and second latch keys 20a and 20b installed in the inner portion of the main plate 10, and the front portion is rotatably supported by bearings 24a and 24b. The first and second worm wheels 22a and 22b are engaged with the first and second worms 30a and 30b. The first and second worms 30a and 30b receive a rotational force of the driving motor 40. The first and second worms 30a and 30b are rotatably in the back surface of the main plate 10 using the fixing brackets 50a and 50b and are connected with the driving shafts 42a and 42b protruded in the left and right directions of the driving motor 40. In particular, the left side driving shaft 42a of the driving motor 40 is connected with the first worm 30a using a coupling 44a. A sub-shaft 46 is connected with the right side-driving shaft 42b using a coupling 44b. The sub-shaft 46 and the second worm 30b are connected with the coupling 44c for thereby transferring a driving force. Both ends of the first and second worms 30a and 30b are supported by the bearings 32a and 32b for a smooth rotation. The first and second worms 30a and 30b and the first and second worm wheels 22a and 22b engaged therewith are received in the protection brackets 50a and 50b and protected therein. A revolution sensor 60 is installed in the back surface of the main plate 10 distanced from the left side driving shaft 42a of the first and second worm wheels 22a and 22b for thereby detecting the revolution of the driving motor 40 and controlling the driving motor 40.

The suction portions 70a and 70b are fixed in the main plate 10 in such a manner that upper and lower pairs of the same are separated each other. The suction portions 70a and 70b are separately fabricated and assembled.

The driving method of the latch key according to the present invention will be explained with reference to the accompanying drawings.

When the driving motor 40 is rotated, the left and right driving shafts 42a and 42b are rotated in the same revolution, and the first and second worms 30a and 30b are rotated in the same revolution. In addition, the first and second worm wheels 22a and 22b engaged with the first and second worms 30a and 30b are rotated in the same revolution for thereby rotating the first and second latch keys 20a and 20b. The revolution of the first and second worm wheels 22a and 22b are decreased based on the number of teeth of the first and second worms 30a and 30b, and the latch keys 20a and 20b are rotated based on the decreased revolution of the first and second worm wheels 30a and 30b. The first and second latch keys 20a and 20b are rotated in the latch key holes formed in the door of the FOUP (not shown) for thereby unlocking or locking the door.

As shown in FIG. 5, the suction portions 70a and 70b are fabricated separately from the body 72 and the pin portion 74. A female screw 72a is formed in the body 72, and a male screw 74a is formed in an adjusting pin 74. A way is formed along the center of each element. A sealing member 76 is formed in the engaging portions for thereby implementing a sealed state.

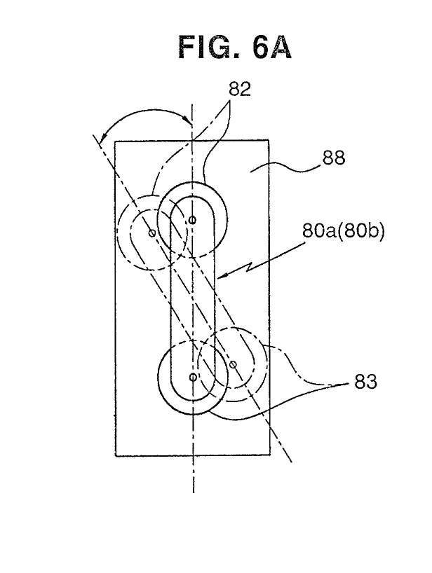

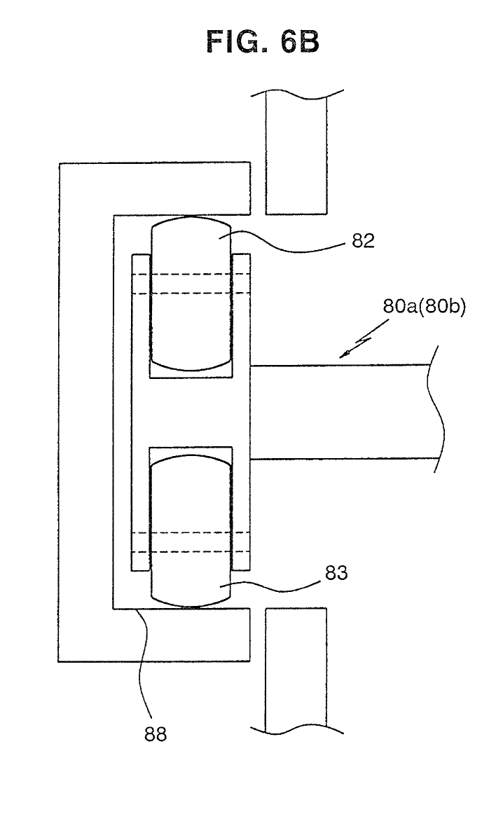

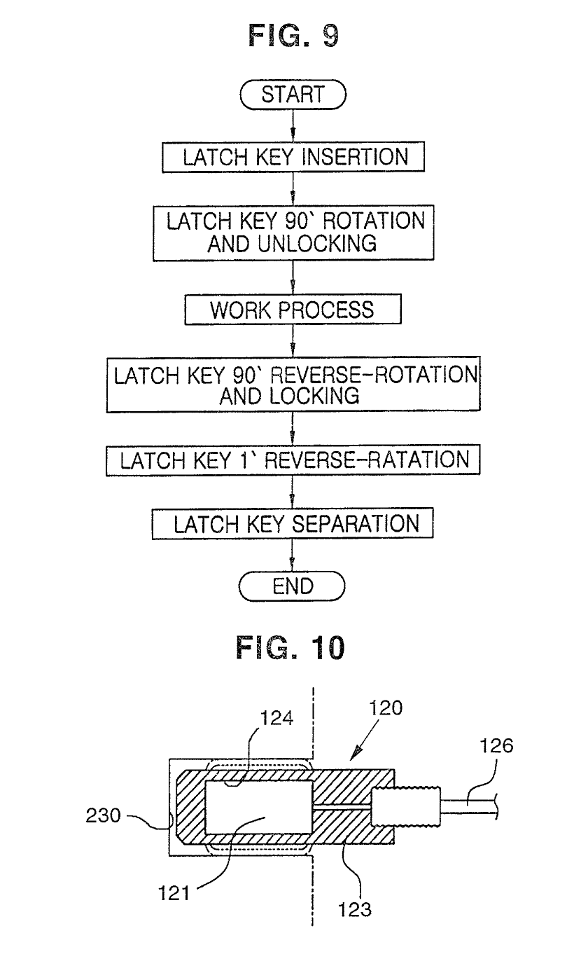

FIGS. 6A and 6B are front and side cross-sectional views illustrating an opener latch key according to another embodiment of the present invention, and FIG. 9 is a flow chart illustrating a latch key control method of a FOUP opener according to another embodiment of the present invention.

As shown therein, the door support unit according to the present invention inserts the latch keys 80a and 80b of the door holder into the latch key hole 88 provided in the door of the FOUP and rotates the same 90° for thereby opening the door (Steps 1 and 2). At this time, a certain margin is formed for an insertion of the latch keys 80a and 80b and the latch key hole 88. The latch keys 80a and 80b are inserted into the latch key hole 88 and are rotated 90°, and the latch keys 80a and 80 are idle-rotated by a margin and is closely contacted with a corresponding surface of the latch key hole 88 for thereby rotating the latch key hole 88.

Therefore, the latch key hole 88 is not rotated 90° by a rotation of the latch keys 80a and 80b, but rotated by the margin. The margin is generally 0.5 mm in the upper and lower directions. Namely, in a state that the centers of the latch key hole 88 and the latch keys 80a and 80b are correctly arranged, the idle state is obtained by about 1° in the left and right directions. Therefore, in a state that the centers of the same are arranged, since the latch key hole 88 is closely contacted and rotated after the latch keys 80a and 80b are rotated about 1°, the latch keys 80a and80b are rotated about 89° based on the rotation of 90° of the latch keys 80a and 80b. When the door is unlocked, the wafer is moved to the cleanness equipment in the FOUP, and the latch keys 80a and 80b are rotated 90° in the direction opposite to the unlocking operation, and then the door is locked again. At this time, the latch keys 80a and 80b closely contacted with the latch key hole 88 in the unlocking direction is rotated in the locking direction which is opposite to the unlocking direction. Therefore, the latch keys 80a and 80b are idle-rotated by 2°, so that the latch keys 80a and 80b are closely contacted with the corresponding surface in the locking direction of the latch key hole 88. After the latch keys 80a and 80b are closely contacted, if the latch keys 80a and 80b and are continuously rotated, it means that the latch key hole 88 is rotated 88°. Therefore, since the latch key hole 88 which is rotated 89° in the unlocking direction is rotated 88° in the opposite direction, it is slanted by 1° in the unlocking direction. The slanted angle may cause an interference during the insertion for thereby causing a friction problem. In the present invention, in order to compensate the above slanted angle, the latch keys 80a and 80b are rotated more 1° in the locking direction, are totally rotated 91° (Steps 3 and 4). Therefore, the latch key hole 88 is more rotated by 1° in the locking direction for thereby returning to the original position. In a state that the latch key hole 88 is positioned in the normal position and the door is locked, the latch keys 80a and 80b are separated from the latch key hole 88. At this time, the latch keys 80a and 80b are closely contacted with the corresponding surface in the latch key hole 88 in the locking direction. When separating the same, a certain abrasion occurs due to the friction identically to the conventional art. Therefore, in the present invention, the latch keys 80a and 80b are reverse-rotated by 1° in the direction opposite to the locking rotation direction, so that the latch keys 80a and 80 are not closely contacted with the latch key hole 88 and are distanced by the margin and then are separated (Steps 5 and 6). The locking and unlocking operations of the door are finished. When the latch keys 80a and 80b are separated from the latch key hole 88, a friction does not occur. When the latch keys 80a and 80b are inserted, since the latch key hole 88 is in the normal position based on the above process, the latch keys 80a and 80b are inserted into the center portion of the latch key hole 88 for thereby preventing a certain interference or collision.

In the present invention, when the latch keys 80a and 80b are inserted into the latch key hole 88 and are rotated, in order to decrease an abrasion due to the friction, as shown in FIGS. 6A and 6B, buffering rollers 82 and 83 are installed at both ends of the latch keys 80a and 80b. The buffering rollers 82 and 84 are fabricated in such a manner that a margin (abut 0.5 mm) is formed with respect to the latch key hole 88. In addition, as shown in FIG. 6B, since the latch key hole 88 has a certain curvature in the thickness direction, it is easy to insert into the latch key hole 88. Namely, the lower insertion portion has a smaller diameter, and the center portion of the same has a larger diameter.

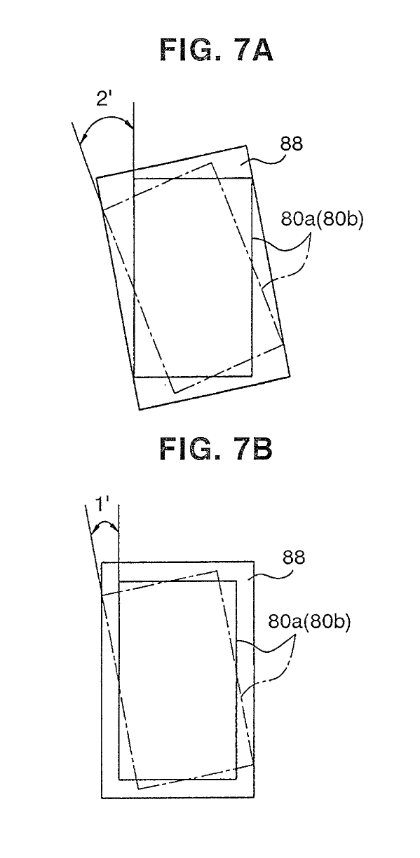

FIGS. 7A and 7B are views illustrating an initial insertion state in which the latch keys are inserted into the latch key holes, in which FIG. 7A is a view illustrating a state that a latch key hole is not positioned in a normal position, but slanted by 1° in a rotation direction, and FIG. 7B is a view illustrating a state that a latch key hole is in a normal position.

As shown in FIG. 7A, in order to unlock the door in the case that the latch key hole 88 is not in the normal position, but slanted in rotation direction by 1°, the latch keys 80a and 80b are inserted into the latch key hole 88 and are rotated 90°, so that the latch keys 80a and 80b are inserted into the latch key hole 88 and idle-rotated 2° and are closely contacted with the corresponding surface for thereby rotating the latch key hole 88. Therefore, the latch key hole 88 is rotated 880 and is stopped at an angle of 89° summing the slanted angle of 1° in the unlocking direction. At the above position, the door is unlocked and opened, and the door is opened, and the process is performed. In order to lock the door, the latch key hole 88 is rotated 91° in the locking direction. The latch keys 80a and 80b are idle-rotated 2° in the locking direction in the latch key hole 88 and is contacted with the corresponding surface in the locking direction for thereby rotating the latch key hole 88. The latch key hole 88 rotated 89° in the unlocking direction is rotated 89° in the locking direction and is in the normal position. Thereafter, the latch keys 80a and 80b are separated from the latch key hole 88, and the locking process is finished. At this time, since the latch key hole 88 and the latch keys 80a and 80b are closely contacted, in the case that the same are forcibly separated, an abrasion problem occurs. Therefore, in the present invention, in order to overcome the above problems, the latch key hole 88 is rotated 1° in the reverse direction, and the latch key hole 88 and the latch keys 80a and 80b are separated from each other.

FIG. 7B is a view illustrating a state that the latch key hole 88 is position in the normal position, and the process is completed. In this case, the latch keys 80a and 80b are inserted into the latch key hole 88 and is idle-rotated 1° and is closely contacted with the corresponding surface for thereby rotating the latch key hole 88. Therefore, when the latch keys 80a and 80b are rotated 90°, the latch key hole 88 is rotated 89° in the unlocking direction for thereby unlocking the door. Since the next processes are performed in the same method as FIG. 7A, the description thereof is omitted.

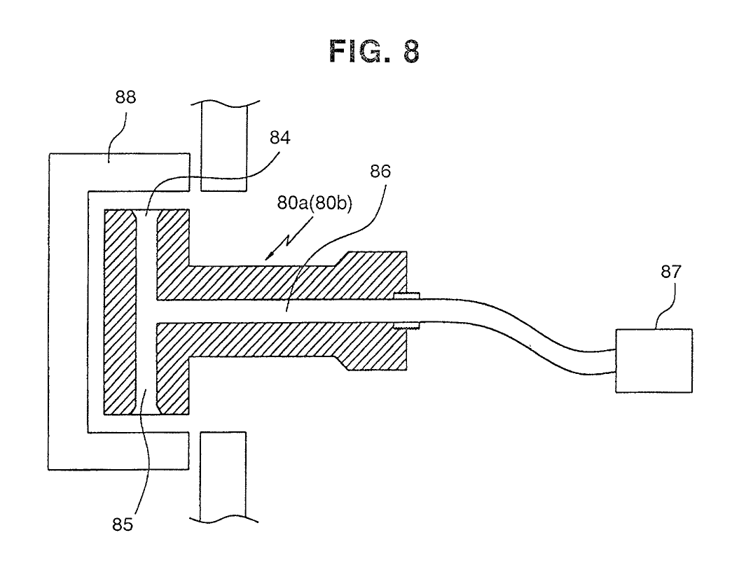

FIG. 8 is a side cross-sectional view illustrating a latch key of a FOUP opener according to another embodiment of the present invention.

The latch key 80b of the opener is inserted into the latch key hole 88 of the FOUP for thereby rotating the latch key hole 88 for unlocking the FOUP. At this time, the particles are formed in the groove of the FOUP transferred from the out side of the process equipment region, particularly in the latch key hole 88. If the above particles are introduced into the process equipment, a critical problem may occurs in the fabrication process of the semiconductor. Therefore, suction holes 84 and 85 are formed in an outer circumferential surface of the latch key 80b, and the suction holes 84 and 85 are connected with a suction and discharging unit 87 of the discharging line 86. Therefore, when the suction and discharging unit 87 is operated, the particles in the latch key hole 88 are forcibly sucked through the suction holes 84 and 85 of the latch key 80b and are discharged to the outside through the discharging line 86. In the above operation, the latch key is inserted into the latch key hole 88, and the suction and discharging unit 87 is driven before the locking stare of the FOUP is unlocked, so that the particles in the latch key hole 88 are sucked through the suction holes 84 and 85 formed in the latch key hole 88 and are discharged to the outside. Therefore, in the present invention, it is possible to prevent the particles from being introduced into the cleanness region for thereby enhancing a cleanness state of the process equipment.

Therefore, in the present invention, it is possible to basically prevent the particles from being introduced into a cleanness region.

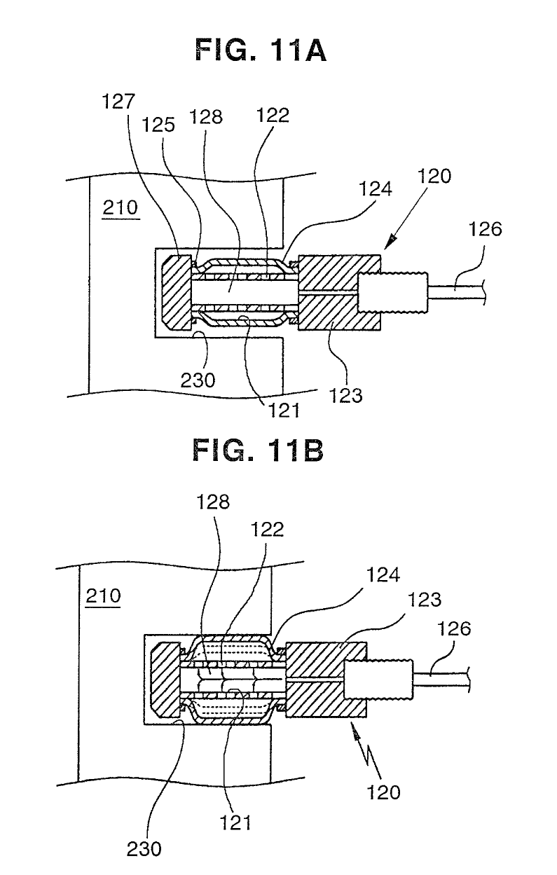

FIG. 10 is a cross-sectional view illustrating a FOUP door support unit of a FOUP opener according to the present invention, and FIGS. 11A and 11B are cross-sectional views illustrating a FOUP door support unit of a FOUP opener according to the present invention.

As shown therein, the support unit 120 of the FOUP door 210 sucks the FOUP door 210 before the FOUP door 210 is opened and maintains a supporting state until the door is separated and moved down and returned to the original position.

The FOUP door support unit 120 is formed in a rod shape, and a guide head 127 is formed at an end potion of the same, and an inner pipe 121 having a certain space 128 is formed at the intermediate portion of the same, and a base portion 123 is formed at the lower portion of the same. A hose 126 is connected with the base portion 123 for transferring a certain pressure air from a compressed air supply unit.

The support unit 120 of FIG. 10 is formed in a hollow flexible material, and the support unit 120 of FIGS. 11A and 11B is different one in another embodiment of the present invention.

An expansion member 124 surrounds the outer portion of the inner pipe 121 of the support unit 120, and the inner pipe 121 has a diameter smaller than the guide head 127 and includes a plurality of discharging holes 122 from the outer side of the inner space 121. The expansion member 124 formed of a flexible rubber material is fixed to the upper and lower portions of the discharging region using a fixing ring 125.

The operation of the FOUP door support unit 120 according to the present invention will be explained with reference to FIG. 11B. As shown therein, the guide head 127 of the support unit 120 is inserted into the suction hole 230 of the FOUP door 210. In this state, when the compressed air is supplied into the space 121 using the compressed air supply unit, the compressed air is flown thereinto through a plurality of the discharging holes 120 formed in the space 121. The expansion member 124 formed of a rubber material is expanded by the compressed air. When the expansion member 124 is expanded, it is closely contacted with an inner surface of the suction hole 230. The contacting force is maintained until the compressed air is supplied thereinto.

The above-described latch key unlocking operation of the FOUP door is implemented in a state that the FOUP door is supported.

The particles formed when supporting the FOUP door and unlocking the door may pollute the inner portions of the FOUP or the process equipment based on a certain operation in which the FOUP door is separated.

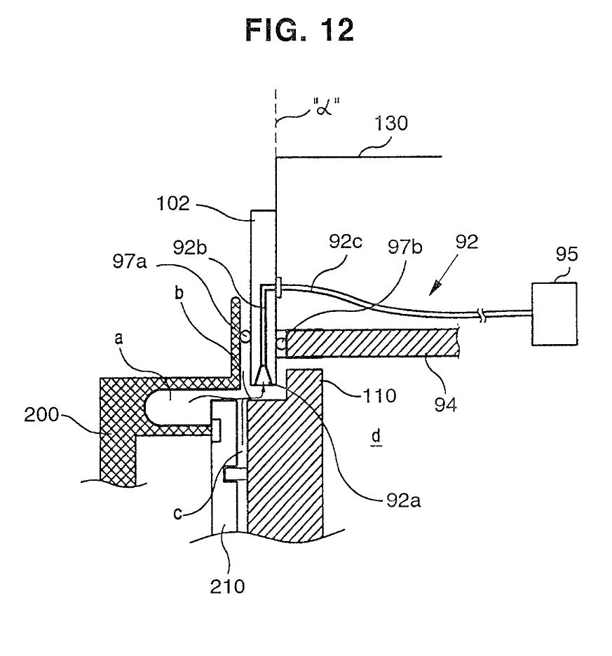

FIG. 12 is a cross-sectional view illustrating a structure of a particle discharging unit of a FOUP opener according to the present invention.

As shown therein, the particle discharging unit 92 is installed at an entrance of the frame which forms the FOUP opener 100 in the particle prevention unit according to the present invention.

The frame 110 of the FOUP and the process equipment 300 have different cleanness in left and right portions with respect to the boundary portion α.

Namely, the vertical frame 102 in which the FOUP opener 100 is positioned with respect to the boundary portion α has a low cleanness, and the process equipment 130 in which the process equipment are installed has a higher cleanness. After the wafer is supplied to the process equipment, the FOUP 200 must have a certain cleanness like the process equipment when opening the FOUP door.

In a stare that the FOUP 200 and the frame 102 are closely contacted, the gap “a” between the door 210 and the FOUP 200, the gap “b” between the FOUP 200 and the frame 102, the gap “c” between the door 210 and the door holder 110, and the inner space portion “d” of the door holder 110 communicate each other.

The nozzle 92a of the particle discharging unit 92 is formed in the direction of the above communicating spaces.

The particle discharging unit 92 includes a nozzle 92a positioned in an opened portion of the frame 102 of the FOUP opener 100 and a suction pipe 92b communicating with the nozzle 92a. The suction pipe 92b is embedded in the interior of the frame 102 and may be formed in a pipe shape in a proper position of the frame 102. A suction hose 92c is connected between the suction and discharging unit 95 in the opposite portion of the suction pipe 92b. The suction and discharging unit 95 is connected with a certain pressure pumping unit or a vacuum compressor. In this case, sealing members 97a and 97b may be provided.

Therefore, the FOUP 200 is moved using the transfer table 106 of the support 104 for opening the door 210 of the FOUP 200, and the FOUP 200 is closely contacted to the side of the door holder 110 of the frame 102. In this state, the particle discharging unit 92 is operated, and the door 210 is separated, so that the particles in the portions a, b, c and d of the space β are discharged to the outside.

The pressure and operation time of the particle discharging unit 92 may be controller if needed until the door is returned to the FOUP after the door opening process.

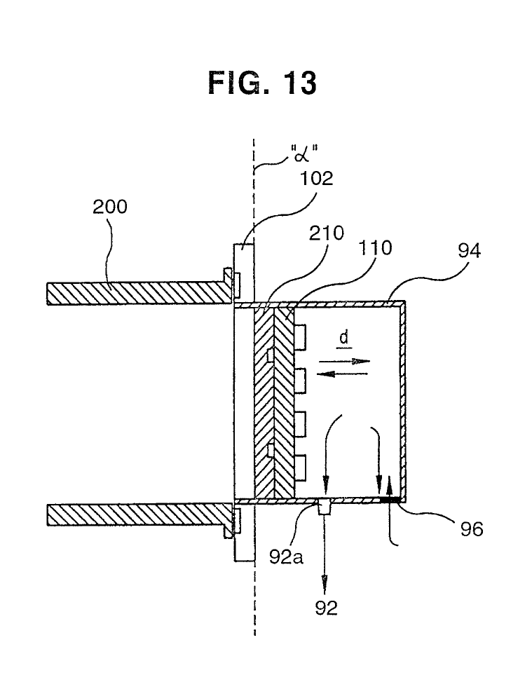

FIG. 13 is a view illustrating a structure for removing the particles from the side of the door holder 110 of the FOUP opener 100 according to the present invention.

A particle discharging unit 92 may be connected with an inner side of the door holder 110. In addition, a particle filter 96 may be provided for a smooth suction and discharging of the air.

When the space “d” of the door holder 110 receives a pressure when the door holder 110 is backwardly moved, the air filtered the particles is discharged to the process equipment 130 through the particle filter 96, and the particle discharging unit 92 is driven for thereby discharging the air having particles to the outside.

In the case that the door 210 is forwardly moved together with the door holder 110, an external air is discharged through the particle discharging unit 92, so that it is possible to prevent the introduction of the remaining particles based on the opening state of the FOUP.

As described above, in the FOUP door opening apparatus, since the latch key operation is implemented based on a direct driving method using a driving motor, it is possible to prevent the lack lash problem, and it is easy to control the system, and an operation stability is obtained, and the number of parts is decreased. In addition, since the latch pin is integrally formed and assembled, it is possible to simplify the structure and the assembling characteristic is improved. Therefore, in the present invention, it is possible to decrease the fabrication cost, and the productivity is enhanced.

In the present invention, the latch key is properly controlled, and the latch key hole is positioned at a set position when finishing the process, so that it is possible to prevent an insertion interference with respect to the latch key in the next process, and a smooth insertion is implemented. In particular, when the latch key is separated from the latch key hole, since the latch key is reverse-rotated by a certain margin in the contact state, it is possible to significantly decrease the abrasion due to a friction when separating the same.

In addition, it is possible to minimize the friction by installing a pair of buffering rollers at both ends of the latch key for thereby preventing an abrasion. When the latch key is rotated in the latch key hole, the buffering roller slides, so that it is possible to prevent a certain abrasion due to the collision.

In the present invention, the particles remaining in a small gap which are formed when the FOUP door of the FOUP opener is opened are prevented, and it is possible to the particles from being introduced into the interior of the FOUP. In addition, the particles remaining in the interior of the door holder are prevented when the door holder is backwardly moved, so that it is possible to basically prevent the particle introduction due to the FOUP opening.

In the present invention, the FOUP door support unit is supported by an expansion of the compressed air compared to the conventional art in which the FOUP door support unit is supported by sucking through the suction plate of the vacuum pressure, so that a large size compressor is not needed. The compressed air supply structure is integrated into one unit for a door operation and support operation using the door opening and closing unit (cylinder type latch key).

Since the FOUP door is supported by the expansion method of the compressed air with respect to the supporting method for the FOUP door of the vacuum suction method, a new FOUP door support unit is provided, so that it is possible to remove a repulsive force which is generated due to an elastic force of a rubber cup of the suction plate support unit of the conventional suction method, whereby it is possible to prevent a stage of the FOUP door from being widened at the last process and the stage from being backwardly moved when closing the door.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalencies of such meets and bounds are therefore intended to be embraced by the appended claims.

What is claimed is:

1. A FOUP door opening apparatus, comprising:
a door opening and closing means; and
a particle discharging means for sucking and discharging a particle to the outside by connecting a suction hole formed in a certain portion of the door opening and closing means and a suction and discharging means having a certain pressure therein when opening and closing then door.

2. The apparatus of claim 1, wherein said door opening and closing means includes a front end having a latch key and an end portion having a worm wheel in which a worm is engaged with the worm wheel, and the worm is connected with a driving motor shaft.

3. The apparatus of claim 1, wherein said door opening and closing means includes buffering rollers at both ends of the same for thereby decreasing a contact friction when the latch key is inserted into the latch key hole and is rotated therein.

4. The apparatus of claim 1, wherein said particle discharging means is installed in a certain position in which the door between the FOUP opener and the FOUP is closely contacted with the door holder.

5. The apparatus of claim 1, further comprising a particle filter installed at a certain portion of a casing which covers the door holder which is backwardly moved from the rear side of the door holder of the FOUP opener.

6. The apparatus of claim 1, wherein said particle discharging means is formed of a nozzle, a discharging hose connected with the nozzle, and a vacuum compressor for providing a discharging force to the discharging hose.

7. The apparatus of claim 1, further comprising a particle discharging formed in an inner center portion of the door opening and closing means for thereby discharging the particles therethrough.

8. The apparatus of claim 1, further comprising a door support means formed of a body having a female screw portion, an adjusting pin having a male screw portion engaged with the female screw portion and a suction way communicating with the body and the adjusting pin.

9. The apparatus of claim 8, wherein a sealing member is disposed between the body and the adjusting pin for implementing a sealed state therebetween.

10. The apparatus of claim 1, further comprising a door support means for supporting a door using an expansion force of a certain pressure by flowing a compressed air.

11. The apparatus of claim 10, wherein said door support means includes a guide head at an end portion of the same for a centering operation, and an intermediate portion formed of an expansion member wherein the expansion member is formed of a base portion for forming a compressed air supply way.

12. The apparatus of claim 11, wherein said expansion member is formed of a two-tier structure of an inner member and an outer member, and the inner member includes a plurality of discharging holes.

13. The apparatus of claim 11, wherein said expansion member includes a fixing ring at upper and lower portions for fixing to the support member.

14. A FOUP door latch key control method, comprising:
a step in which when a latch key inserted in a latch key hole is rotated 90°, the latch key is idle-rotated about 1˜2°, and the latch key is closely contacted with a corresponding surface of the latch key hole in a rotation direction for thereby rotating the latch key hole and unlocking the door;
a step in which the unlocked door is opened, and a process is performed;
a step in which when the process is finished, the door is closed, and the latch key is rotated 91° in the direction opposite when unlocking the latch key in the latch key hole for thereby locking the door; and
a step in which when the door is locked, the latch key is reverse-rotated 1° in the direction opposite to the locking direction, and the latch key hole is arranged with the latch key for thereby separating the latch key from the latch key hole.

15. The method of claim 14, wherein said step for unlocking the door, in the case that the latch key hole is not in the normal position in the previous process, but in a position slanted at an angle of 1°, the latch key is inserted into the latch key hole and is idle-rotated 2° and is closely contacted with the corresponding surface, and then the latch key is rotated.

16. The method of claim 15, wherein in said step for unlocking the door, in the case that the latch key hole is in the normal position in the previous process, the latch key is inserted into the latch key hole and is idle-rotated 1° and is closely contacted with the corresponding surface for thereby rotating the latch key hole.
